(19) United States
(12) Patent Application Publication
(10) Pub. No.: US 2019/0074656 A1
(43) Pub. Date: Mar. 7, 2019

(54) FIBER LASER SYSTEM AND METHOD FOR GENERATING PULSE LASER LIGHT

(71) Applicant: National Tsing Hua University, Hsinchu City (TW)

(72) Inventors: Ci-Ling Pan, Hsinchu City (TW); Hsiao-Hua Wu, Hsinchu City (TW); Pin-Han Huang, Changhua County (TW)

(73) Assignee: National Tsing Hua University, Hsinchu City (TW)

(21) Appl. No.: 15/818,760

(22) Filed: Nov. 21, 2017

(30) Foreign Application Priority Data
Sep. 6, 2017 (TW) 106130415

(51) Int. Cl. H01S 3/13; H01S 3/067; H01S 3/10; H01S 3/16; H01S 3/136

(52) U.S. Cl. CPC H01S 3/1308; H01S 3/06791; H01S 3/1305; H01S 3/09415; H01S 3/10061; H01S 3/1618; H01S 3/136; H01S 3/06712

(57) ABSTRACT

A fiber laser system includes a fiber laser, a laser light detecting apparatus, and a control apparatus. The fiber laser outputs a laser light, including a noise-like pulse laser light, a mode-locked pulse laser light, or a continuous-wave laser light. The laser light detecting apparatus consists of a lens and a photodiode. The photodiode absorbs the laser light outputted from the fiber laser and generates an output signal in terms of a two-photon absorption effect. The control apparatus reads the output signal of the photodiode and automatically adjusts the fiber laser, according to a preset value, to obtain the noise-like pulse laser light or the mode-locked pulse laser light.

### CROSS-REFERENCE TO RELATED APPLICATION

This application claims the priority benefit of Taiwan application serial no. 106130415, filed on Sep. 6, 2017. The entirety of the above-mentioned patent application is hereby incorporated by reference herein and made a part of this specification.

### BACKGROUND

### 1. Field of the Invention

The invention relates to a fiber laser, and particularly relates to a fiber laser system and a method for generating a pulse laser light that are capable of automatically outputting the selected pulse laser light.

### 2. Description of Related Art

As ultra-fast laser light sources become more and more important in the industry, academic research and medical applications, users' demands for a stable and reliable pulse laser light source also increase day by day.

A fiber laser has the advantages of small volume, light weight, good heat dissipation, good light beam quality, and high energy conversion efficiency. Consequently, the fiber laser as a picosecond or femtosecond pulse light source is gaining more and more attention.

In terms of operation, the fiber laser may produce modes that include a mode-locked pulse and a noise-like pulse, and the noise-like pulse has been proven to have good performance in optical coherence tomography (OCT) and laser-induced breakdown spectroscopy (LIBS).

In traditional methods, it is necessary to manually adjust a polarization control component inside the lase cavity to switch the laser light from a continuous-wave output to a pulsed output. Such methods are more time-consuming, and it is more difficult to timely locate the required position to adjust polarization of the pulse laser light.

In existent automatic control methods, in order to obtain an output of the noise-like pulse or an output of the mode-locked pulse, it is necessary to use back-end instruments to synchronously monitor parameters such as spectral width, the pulse sequence, and the autocorrelation interference graph to adjust and confirm the desired mode.

If it is possible to build a laser system that automatically outputs the required pulse, it will be more convenient to the users.

### SUMMARY OF THE INVENTION

The invention relates to a fiber laser capable of outputting two kinds of pulse light beams with different properties, that is, a noise-like pulse and a mode-locked pulse. In the invention, properties of two-photon absorption (TPA) are utilized so that an output of the noise-like pulse or an output of the mode-locked pulse may be selected easily and automatically.

According to an embodiment, the invention provides a fiber laser system, including a fiber laser, a laser light detecting apparatus, and a control apparatus. The fiber laser outputs a laser light that includes a noise-like pulse laser light, a mode-locked pulse laser light, or a continuous-wave laser light. The laser light detecting apparatus consists of a lens and a photodiode. The photodiode absorbs the laser light outputted from the fiber laser and generates an output signal in terms of a two-photon absorption effect. The control apparatus reads the output signal of the photodiode and automatically adjusts the fiber laser, according to a preset value, to obtain the noise-like pulse laser light or the mode-locked pulse laser light.

According to an embodiment, in the fiber laser system, the photodiode generates an output signal that has two stable voltages in terms of the two-photon absorption states of the different pulses respectively.

According to an embodiment, in the fiber laser system, one of the pulse laser lights is selected using a preset value.

According to an embodiment, in the fiber laser system, the control apparatus, by a computer system, adjusts an optical component configured to change a polarization state in the fiber laser, thereby obtaining the required pulse laser light.

According to an embodiment, in the fiber laser system, the fiber laser is a nonlinear polarization rotation fiber laser or a nonlinear amplifying loop mirror fiber laser.

According to an embodiment, in the fiber laser system, the fiber laser is a nonlinear polarization rotation fiber laser, including a polarization beam splitter adjusting a polarization state inside a laser cavity using the control apparatus, thereby forming an output of the pulse laser light.

According to an embodiment, in the fiber laser system, the polarization beam splitter includes two kinds of structures: first, a structure including a first quarter-wave plate that is rotatable, a second quarter-wave plate that is rotatable, a half-wave plate that is rotatable, and a polarization beam splitter lens; second, a structure including a first polarization controller that is adjustable, a second polarization controller that is adjustable, and a fiber-optical polarization beam splitter or a polarizer paired with a fiber coupler. The polarization beam splitter, the fiber-optical polarization beam splitter, or the fiber coupler serves as a laser output end to direct the laser light out to enter the control apparatus. Herein the control apparatus automatically controls respective rotating angles of the first quarter-wave plate, the second quarter-wave plate and the half-wave plate, or the first polarization controller and the second polarization controller.

According to an embodiment, in the fiber laser system, the first quarter-wave plate and the half-wave plate are disposed adjacent to each other and have opposite rotating directions.

According to an embodiment, in the fiber laser system, the fiber laser has a ring-shaped cavity path, and further includes a light isolator ensuring that the laser light in the cavity travels in the same direction, a laser diode emitting a laser pump light, and a Yb-doped fiber receiving the laser pump light to perform amplification.

According to an embodiment, in the fiber laser system, the fiber laser is a nonlinear amplifying loop mirror fiber laser and includes a polarization control device. The polarization control device includes a polarization controller provided on a ring-shaped fiber cavity path. The polarization controller is adjusted by the control apparatus to obtain the pulse laser light as outputted.

According to an embodiment, in the fiber laser system, the fiber laser includes a liquid crystal phase retarder, which is adjusted by the control apparatus to obtain the pulse laser light as outputted.

According to an embodiment, in the fiber laser system, the photodiode is a GaAsP photodiode.

According to an embodiment, in the fiber laser system, the laser light detecting apparatus further comprises a focus lens that focuses the pulse laser light outputted from the fiber laser to be inputted to the photodiode.

According to an embodiment, the invention provides a method for generating a pulse laser light, which includes outputting a pulse laser light using a fiber laser, wherein the pulse laser light includes a noise-like pulse light laser or a mode-locked pulse laser light; absorbing the pulse laser light using a photodiode, wherein a two-photon absorption signal of the photodiode has two stable absorption states, which are distinguishable, in terms of the noise-like pulse light laser and the mode-locked pulse laser light; and by a control apparatus, reading an output signal of the photodiode and automatically adjusting the fiber laser, according to a selection between the two stable absorption states, to obtain the noise-like pulse laser light or the mode-locked pulse laser light.

According to an embodiment, in the method for generating a pulse laser light, the two stable absorption states are two stable voltage states in terms of an output signal of the photodiode.

According to an embodiment, in the method for generating a pulse laser light, one of the two stable absorption states is selected using a threshold value.

According to an embodiment, in the method for generating a pulse laser light, the control apparatus, by a computer system, adjusts an optical component configured to change a polarization state in the fiber laser, thereby obtaining the pulse laser light as outputted.

According to an embodiment, in the method for generating a pulse laser light, the fiber laser is an all-normal-dispersion fiber laser, and includes a polarization beam splitter adjusting nonlinear polarization rotation using the control apparatus, thereby changing a polarization state of the pulse laser light.

According to an embodiment, in the method for generating a pulse laser light, the polarization beam splitter includes a first quarter-wave plate that is rotatable, a second quarter-wave plate that is rotatable, a half-wave plate that is rotatable, and a polarization beam splitter lens directing the pulse laser light out to enter the control apparatus. Herein the control apparatus automatically controls respective rotating angles of the first quarter-wave plate, the second quarter-wave plate and the half-wave plate.

According to an embodiment, in the method for generating a pulse laser light, the fiber laser includes a polarization control device or a liquid crystal phase retarder that is controlled by the control apparatus to obtain the pulse laser light as outputted.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a fiber laser system according to an embodiment of the invention.

FIG. 2 is a schematic view of a fiber laser system according to an embodiment of the invention.

FIG. 3 shows an autocorrelation interference curve of a noise-like pulse according to an embodiment of the invention.

FIG. 4 shows an autocorrelation interference curve of a mode-locked pulse according to an embodiment of the invention.

FIG. 5 illustrates a curve of a two-photon absorption signal (in a linear scale) according to an embodiment of the invention.

FIG. 6 illustrates a curve of a two-photon absorption signal (in a log-log plot) according to an embodiment of the invention.

FIG. 7 shows how a TPA signal amplitude affects the pulse quality according to an embodiment of the invention.

FIG. 8 shows a TPA signal in a stable state according an embodiment of the invention.

FIG. 9 shows a TPA signal in an unstable state according an embodiment of the invention.

FIG. 10 shows results of performing continuous measurement by autocorrelation interference curves of noise-like pulses according to an embodiment of the invention.

FIG. 11 is a schematic view of an all-fiber laser system according to an embodiment of the invention.

FIG. 12 is a schematic view of an all-normal-dispersion fiber laser system according to an embodiment of the invention.

FIG. 13 is a schematic view of a non-all-fiber laser system that uses a liquid crystal as a polarization control component according to an embodiment of the invention.

FIG. 14 is a schematic view of a figure-8 fiber laser system according to an embodiment of the invention.

FIG. 15 is a schematic view of an all-fiber laser system that uses a single polarization controller according to an embodiment of the invention.

### DESCRIPTION OF THE EMBODIMENTS

In the present application, a photodiode, such as a GaAsP photodiode, is used to determine whether an output mode is a “noise-like pulse” or a “mode-locked pulse.” Herein the polarization state of a laser is automatically adjusted according to the selected output mode so as to achieve a stable output automatically and quickly.

The mechanism of mode distinction lies in that the photodiode generates a two-photon absorption (TPA) signal that has two states in terms of the noise-like pulse and the mode-locked pulse respectively. That is to say, in the same energy state, the noise-like pulse has a higher TPA signal than the mode-locked pulse.

In the invention, an automatic control apparatus is used to control automatic rotation of a set of quarter-wave plate/a half-wave plate/a quarter-wave plate to obtain a stable pulse output of the fiber laser. Regarding the outputted laser light, it is easy to determine whether the output state is the “noise-like pulse” or the “mode-locked pulse” by using the photodiode to detect the amplitude of the TPA signal. In this way, it is easy and fast to meet the requirement of outputting the “noise-like pulse” or the “mode-locked pulse.”

In terms of operational efficiency, the output of the “noise-like pulse” may be achieved within 6 minutes. In terms of devices, only the photodiode is required for receiving the outputted laser light so as to generate the TPA signal. The hardware installation is more lightweight and the cost is low, which is conducive to applicability.

In other words, by using the TPA signal as a feedback signal of automatic control, the laser locates the noise-like pulse output or the mode-locked pulse output according to the signal, and an intelligent mode-locked fiber laser system may then be built.

In the invention, a plurality of embodiments are provided for illustration, but the invention is not limited thereto.

In the following, an intelligent mode-locked fiber laser according to preferred embodiments of the invention is explicated with reference to the related drawings, wherein the same elements are illustrated with the same reference symbols.

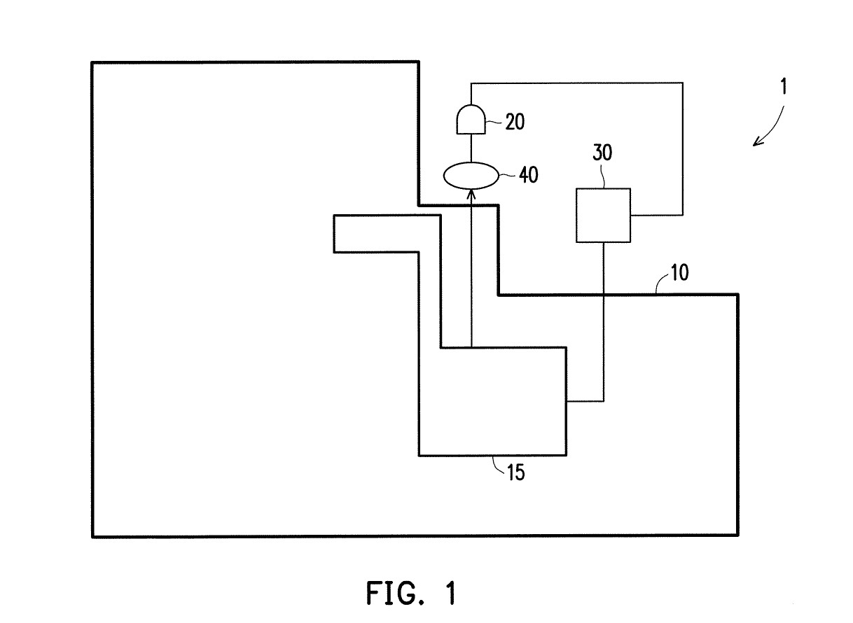

FIG. 1 is a schematic view of a fiber laser system according to an embodiment of the invention. In the invention, a fiber laser system 1 includes a fiber laser 10, a photodiode 20, and a control apparatus 30. The fiber laser 10 includes a polarization beam splitter 15 that changes the polarization state of a laser light in the fiber laser 10 by using a nonlinear polarization rotation effect, so that the fiber laser 10 generates a noise-like pulse or a mode-locked pulse. The control apparatus 30 is, for example, a computer system.

For the purpose of producing a pulse laser with concentrated energy, a generally adopted method is to adjust the polarization state inside a laser cavity. For the purpose of changing the polarization state of light, a common method is to use a combination of two quarter-wave plates and one half-wave plate to change the polarization state of the light incident inside the fiber into any polarization state, and then to output the light from the rear end of the fiber.

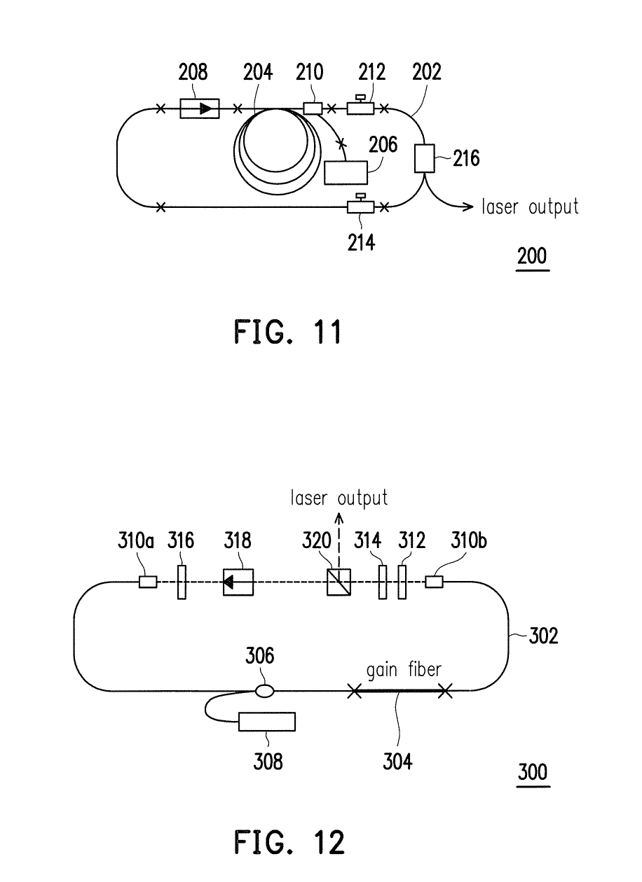

It is also a common method to change the polarization state of light by using a polarization controller (PC), as shown in FIG. 11, for example. When the fiber is wrapped around three discs, the discs may equivalently serve as quarter or half-wave plates depending on the number of turns of the wrapped fiber. By rotating the three discs, stresses of different strengths are applied to the fiber, and the stressed fiber then affects the polarization state of the light propagated inside the fiber. In addition, a liquid crystal phase retarder may also be used as a replacement. The invention is not limited to any specific method.

In another kind of polarization controller called the electronic polarization controller (EPC), the objective of polarization adjustment is also achieved by applying stresses to the fiber. However, here it is achieved through three thermal electrodes, wherein different values of the applied voltages are used to generate a heat-induced stress and to adjust the polarization state. A more specific configuration is shown in FIG. 11 in the following.

The polarization beam splitter 15 of the invention may be any polarization controller capable of adjusting the polarization state of a laser light and is not limited to those mentioned in the present specification.

The polarization beam splitter 15 is controlled by the control apparatus 30 to adjust the polarization state of the polarization beam splitter 15, so that the fiber laser 10 generates the required noise-like pulse or mode-locked pulse in accordance with the use.

The pulse light beam emitted by the fiber laser 10 is focused on the photodiode 20 by a focus lens 40. If the pulse intensity of the laser light is high enough, the focus lens 40 may not be needed.

The control apparatus 30 reads the intensity of the TPA signal generated by the photodiode 20, thereby determining whether the pulse emitted by the fiber laser 10 is a noise-like pulse or a mode-locked pulse. Then, the control apparatus 30 outputs a feedback signal to the polarization beam splitter 15 of the fiber laser 10 to change the polarization state of the fiber laser 10, so that the fiber laser 10 outputs the required pulse mode.

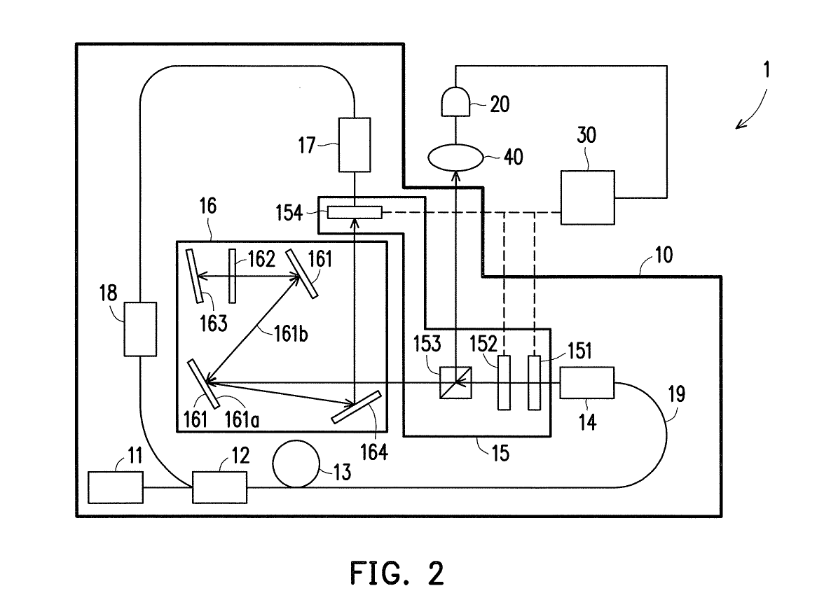

FIG. 2 is a schematic view according to another embodiment of the invention. A fiber laser 10 is a Yb-doped fiber laser structure with a ring-shaped cavity, including a pump light source 11, a power synthesizer 12, a Yb-doped fiber 13, a first fiber collimator 14, a polarization beam splitter 15, a light modulator 16, a second fiber collimator 17, and a light isolator 18.

The pump light source 11 includes one or more laser diodes to emit a laser light, and the wavelength of the laser light has a high absorption ratio within the absorption line of Yb ions.

The power synthesizer 12 is connected to the pump light source 11 and the light isolator 18 by a passive fiber F, so that a pump light generated by the pump light source 11 is transmitted to the power synthesizer 12, and is synthesized with a laser light from the light isolator 18 and outputted to the Yb-doped fiber 13.

The power synthesizer 12 outputs the pump light and the laser light to the Yb-doped fiber 13. The Yb-doped fiber 13 is a structure with a double cladding layer, and its core is doped with a rare earth element ytterbium (Yb). The pump light is propagated in total reflection inside the inner cladding layer and is absorbed by ions of the rare earth element when passing through the core, so that the laser light obtains energy gain when advancing in the core of the Yb-doped fiber 13.

The Yb-doped fiber 13 outputs a laser light signal to the first fiber collimator 14 by the passive fiber F. The first fiber collimator 14 converts the laser light signal into a collimated light and inputs the collimated light to the polarization beam splitter 15.

The polarization beam splitter 15 includes a first quarter-wave plate 151, a half-wave plate 152, a polarization beam splitter lens 153, and a second quarter-wave plate 154. In this embodiment, the three waveplates, i.e. the first quarter-wave plate 151, the half-wave plate 152 and the second quarter-wave plate 154, are installed on three electronic rotation stages, so that it is convenient to automatically control the rotation of the three waveplates respectively by the control apparatus 30 to obtain a laser pulse output.

For example, the first quarter-wave plate 151 and the half-wave plate 152 are disposed adjacent to each other. In a single adjustment, the control apparatus 30 rotates the first quarter-wave plate 151 and the half-wave plate 152 in opposite rotating directions at a set angle. The control apparatus 30 analyzes a TPA signal of a photodiode 20. When the output signal is greater than a threshold value, it is then determined that the output mode is a noise-like pulse; if otherwise, then the output mode is a mode-locked pulse. In addition, an overall adjustment may also be made to the second quarter-wave plate 154. There are more detailed descriptions in the following.

In addition, the threshold value used to distinguish between the noise-like pulse and the mode-locked pulse may be adjusted according to the change of operation power. Therefore, data of the operation table may be prepared in advance and are automatically set by the control apparatus 30.

The collimated light generated by the first fiber collimator 14, after sequentially passing through the first quarter-wave plate 151 and the half-wave plate 152, is incident to the polarization beam splitter lens 153. The polarization beam splitter lens 153 then outputs a parallel light to the light modulator 16.

The light modulator 16 includes a grating pair 161 that consists of, for example, two gratings 161a and 161b, an iris 162, a first reflecting mirror 163, and a second reflecting mirror 164. Herein the iris 162 has an aperture. The parallel light inputted from the polarization beam splitter lens 153, after passing through the grating pair 161, penetrates through the aperture of the iris 162 and is incident to the first reflecting mirror 163 to form a reflected light. The reflected light penetrates through the aperture of the iris 162 again. And after passing through the grating pair 161, the reflected light is incident to the second reflecting mirror 164 to be coupled into the ring-shaped cavity path.

A laser light outputted from the second reflecting mirror 164 penetrates through the second quarter-wave plate 154 of the polarization beam splitter 15. After being collimated by the second fiber collimator 17, the laser light is outputted to the light isolator 18, and is then coupled to the power synthesizer 12 to complete the ring-shaped cavity.

The laser light signal generated by the fiber laser 10 is outputted from the polarization beam splitter lens 153 and is focused on the photodiode 20 by a focus lens 40, and the intensity of the TPA signal of the photodiode 20 is read by the control apparatus 30.

Different semiconductor materials have different bandgap widths. If the bandgap of a semiconductor material is greater than the energy possessed by a photon, a two-photon absorption (TPA) effect is then generated; that is, an electron, after absorbing two photons, is made to transit from a ground state to an excited state. For laser systems with different wavelengths, photodiodes made of semiconductor materials that have suitable bandgap widths may be respectively chosen to generate the TPA effect.

Two-photon absorption (TPA) is a nonlinear effect, and the TPA signal is proportional to the square of the light intensity. Since the energy of the pulse is more concentrated than that of a continuous wave, the pulse thus has a high peak intensity. Consequently, the pulse produces a TPA phenomenon while the continuous wave does not generate TPA.

In this embodiment, the pulse generated by the laser system has a wavelength of about 1064 nm, for example, which is equivalent to the energy of one photon, that is, about 1.24 eV. Consequently, a two-photon photodiode made of a GaAsP material is chosen for this embodiment. Since the bandgap of GaAsP is about 1.8 eV, the electron must absorb the energy of two photons at one time to be able to be excited to the excited state, thereby producing an output of photocurrent or photovoltage. And this photovoltage is none other than the TPA signal.

For laser systems with different wavelengths, photodiodes made of suitable semiconductor materials may be respectively chosen to generate the TPA signal. The selection of the laser system and the photodiode is not limited thereto.

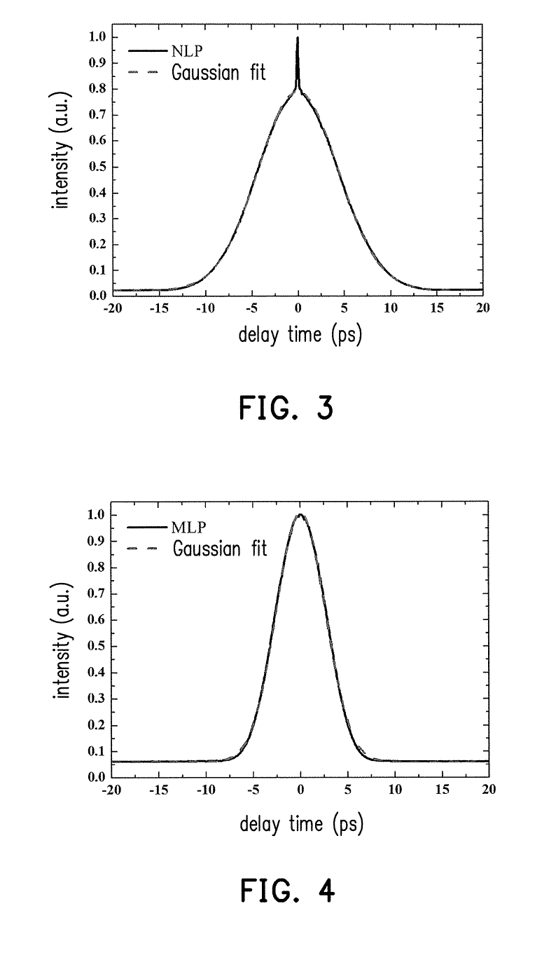

In this embodiment, the fiber laser 10 may generate a noise-like pulse or a commonly seen mode-locked pulse. FIG. 3 shows an autocorrelation interference curve of the noise-like pulse generated by the fiber laser 10 in this embodiment. It is observed that there is a sharp peak when the delay time is close to zero. This peak means that the noise-like pulse has a high light intensity. In the case of the noise-like pulse, a pulse width of about 7 ps is usually obtainable.

FIG. 4 shows an autocorrelation interference curve of the mode-locked pulse generated by the fiber laser 10 in this embodiment. Compared to the autocorrelation interference curve of the noise-like pulse in FIG. 3, there is no abnormally protruding peak when the delay time is close to 0. The pulse width is about 4 ps.

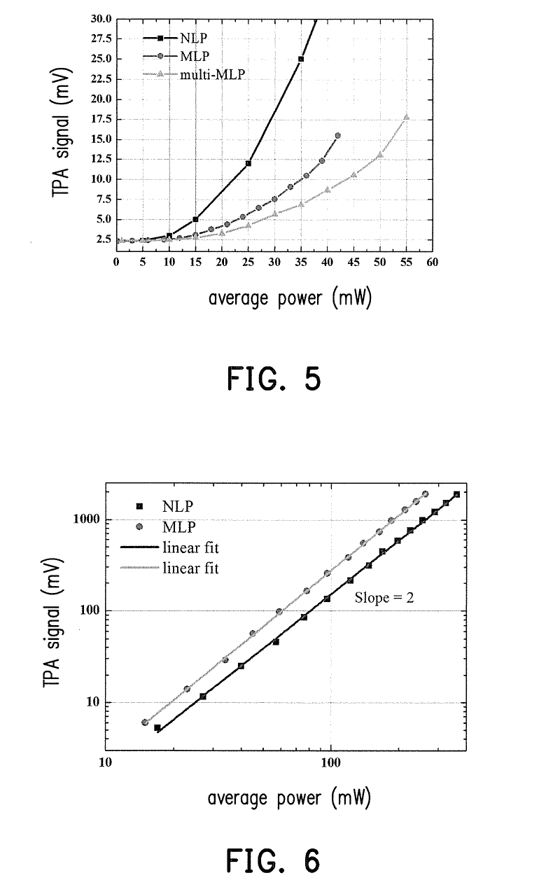

Since the noise-like pulse and the mode-locked pulse have different absorption intensities regarding the two-photon photodiode, it is possible to distinguish these two different pulse modes by the differences between the absorption intensities. FIG. 5 illustrates a curve showing the average power versus the two-photon absorption signal. Under the condition of the same average power, the noise-like pulse has the same energy as the mode-locked pulse. Under the condition of the same energy state, the noise-like pulse generates a higher TPA signal than the mode-locked pulse. The noise-like pulse is marked by square points, and the mode-locked pulse is marked by round dots. In addition, triangular points mark the multiple mode-locked pulse. The multiple mode-locked pulse is also a pulse that may occur when the waveplates are rotated, but its applicability is more limited.

FIG. 6 shows a two-photon absorption curve in a log-log plot. The slope of the two-photon absorption curve equals 2, meaning that the detected signal is indeed generated by the TPA effect.

In this embodiment, it is also possible to easily switch the pulse of the fiber system and distinguish the pulse mode by using the threshold value. When the pulse output is obtained by adjusting the polarization state inside the cavity, a stable output state is obtained using mechanical control, and then a quick analysis is performed using the TPA signal of the photodiode to determine whether the pulse mode is the noise-like pulse or the mode-locked pulse.

In this embodiment, the three waveplates inside the cavity are installed on the electronic rotation stages respectively, and are rotated by control of a computer program. When the waveplates are rotated to produce a pulse laser output, the two-photon photodiode then generates a TPA signal with a corresponding intensity. Based on the signal, the computer program identifies the pulse mode of the pulse, and commands the electronic rotation stages to stop rotating.

Specifically, the method of locating the pulse is as follows: (1) first of all, rotate the first quarter-wave plate 151 and the half-wave plate 152 positioned before the polarization beam splitter lens 153 in opposite directions; after the first quarter-wave plate 151 and the half-wave plate 152 are rotated by 90 degrees at a distance of 2 degrees per step, rotate the second quarter-wave plate 154 positioned after the polarization beam splitter lens 153 by 2 degrees; then go back to rotate the first quarter-wave plate 151 and the half-wave plate 152 positioned before the polarization beam splitter lens 153. Herein the degree of movement per step and the rotating directions are all adjustable. (2) When the waveplates are rotated, the control apparatus 30 constantly reads the TPA voltage signal. When the voltage is higher than a preset target value or is within a preset voltage range, the control apparatus 30 then commands the waveplates to stop rotating immediately; that is, the pulse signal is located. (3) In the case where the voltage is unstable or the pulse suddenly disappears (i.e. the voltage drops to 0) after the waveplates stop rotating, go back to the first step to relocate the pulse.

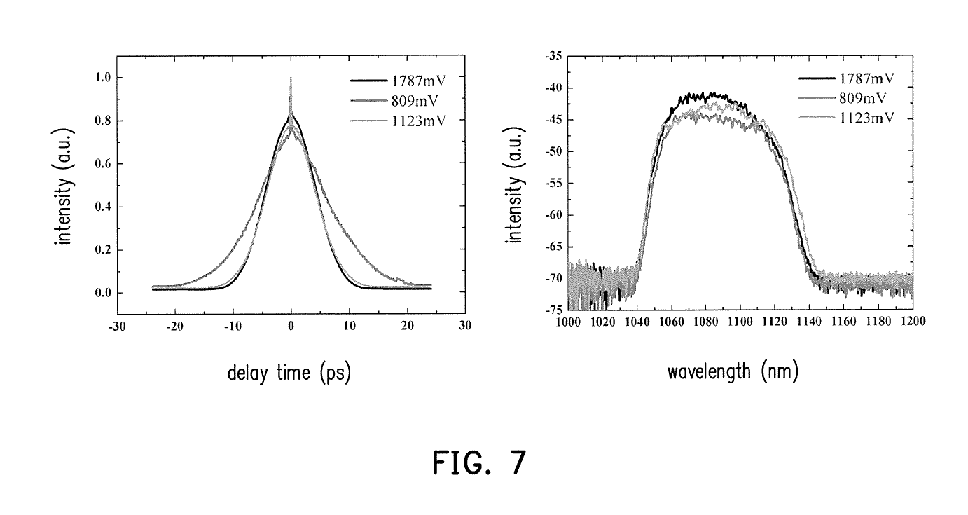

The TPA signal obtained by the control apparatus 30 may be used to determine the quality of the pulse outputted by the fiber laser 10. FIG. 7 shows how a TPA signal amplitude affects the pulse quality. The left image shows that when the pulses are located and the waveplates stop rotating, the three TPA signals detected at this time have different intensities that are distributed in a range of 0.8-1.7V. When the absorption voltage is smaller, the pulse width is wider and the curve is more oscillating as a whole, which means that the pulse quality is poorer. The right image shows the spectra measured by a spectrometer, and there is almost no difference between the three spectra. In light of the above, it is ineffective to use the spectrum measured by the spectrometer as a feedback signal. By comparison, the invention proposes to make a determination by detecting the voltage of the signal.

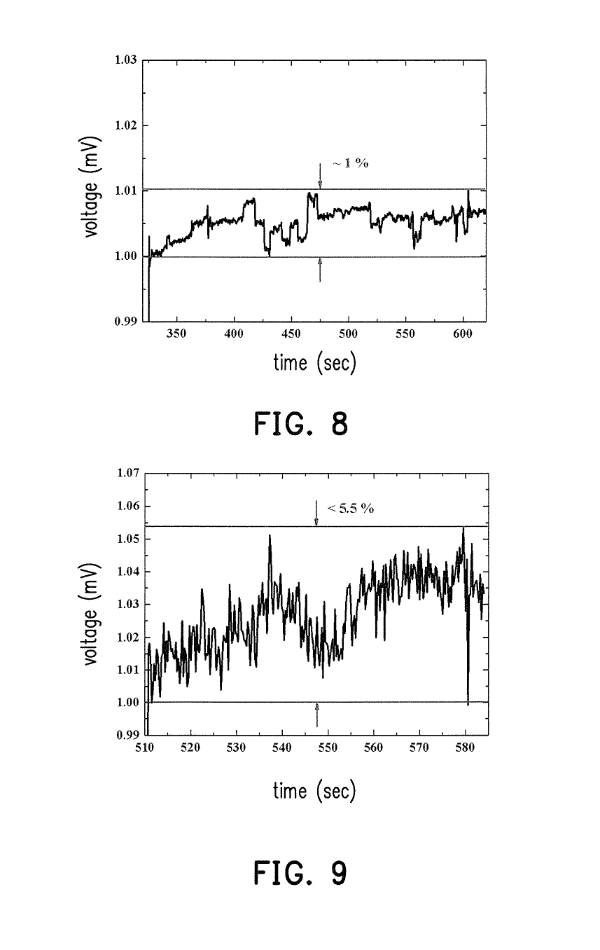

FIG. 8 shows a TPA signal in a stable state according an embodiment of the invention. In this embodiment, when the program is executed, the degree of change of the TPA voltage signal relative to time is measured as time goes by. When the pulse output starts, the amplitude of the upward and downward oscillation of the output voltage is, for example, within 1%, and thus it is determined that the pulse output has reached the stable state. By comparison with the threshold value of the voltage, it is possible to further determine whether the mode is a noise-like pulse laser light or a mode-locked pulse laser light.

Based on the voltage quality of the signal as observed, it is also possible to determine that the pulse quality is in a relatively unstable state. FIG. 9 shows a TPA signal in an unstable state according an embodiment of the invention. The voltage as measured is rather unstable, and the amplitude of oscillation of the signal is, for example, within about 5.5%, which is greater than the amplitude of 1% in FIG. 8. So the autocorrelation graph as measured also presents a rather oscillating view, which means that the pulse quality in this state is not good. The mechanism of determining the pulse quality as described above is only an embodiment. The invention is not limited to any specific method of determination.

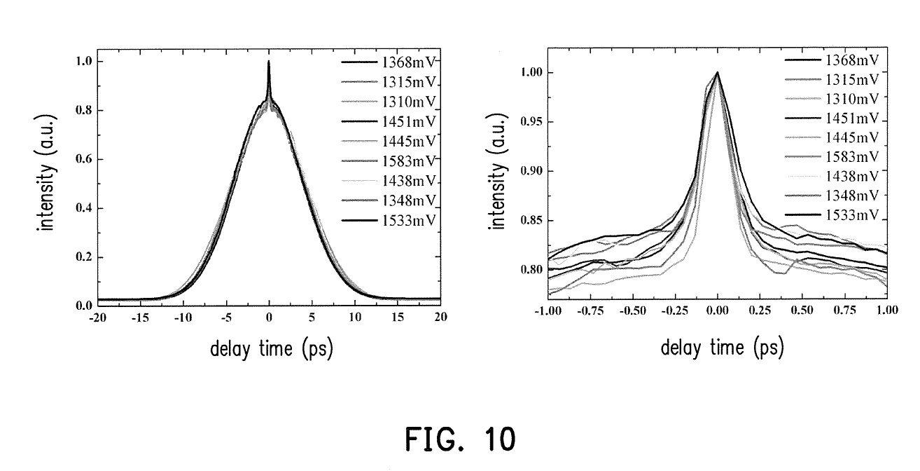

FIG. 10 shows results of performing continuous measurement according to an embodiment. When the TPA signal is greater and more stable, the laser has a noise-like pulse output with better quality. Consequently, a higher target voltage may be set for the program, and the voltage stability after the waveplates stop rotating is used as a ground for determination. In this embodiment, the program performs nine measurements, and each time the three waveplates are set to three random angles beforehand. Noise-like pulse outputs with good pulse quality are obtained in all these nine times, and the pulse waves are very close to one another in shape, each with a pulse width of about 7 ps. The right image is an enlarged view of the peak in the left image, with a width of about 250 fs. Consequently, the method to detect the output voltage of the TPA signal of the photodiode as proposed in the invention may be used to determine the pulse quality. Such method, by a comparison with the preset threshold value of the voltage, may also be used to determine whether the output pulse is a noise-like pulse or a mode-locked pulse. If the output value is higher than the threshold value of the voltage, then it is determined that the output pulse is a noise-like pulse, and if the output value is lower than the threshold value of the voltage, then it is determined that the output pulse is a mode-locked pulse.

In the invention, the absorption signal of the photodiode is used as a feedback signal of feedback control for determining the quality and mode of the output pulse. The invention is applicable to any fiber laser that may generate a noise-like pulse or a mode-locked pulse, and is not limited to a specific fiber laser.

Generally speaking, there are many kinds of laser structures that obtain a pulse output by adjusting the polarization state inside the laser cavity, such as a figure-8 fiber laser using a nonlinear amplifying loop mirror (NALM), and an all-normal-dispersion fiber laser (ANDiFL) using nonlinear polarization rotation (NPR). There are also many kinds of components for tuning and controlling the polarization state inside the cavity, such as a polarization controller or a liquid crystal phase retarder. As long as the pulse is generated by adjusting the polarization state inside the cavity, such laser cavity structure combined with electronically controlled polarization selecting components may then be paired with the method of using the TPA signal as the feedback signal as claimed in this patent application to build an intelligent mode-locked fiber laser system. The classification of pulse fiber lasers is as shown in Table 1, for example, but applications of the invention are not limited to the pulse fiber lasers listed below.

TABLE 1

| | | |
|---|---|---|
| pulse fiber laser | nonlinear polarization | dispersion-mapped |
| | rotation | fiber laser |
| | | all-normal-dispersion |
| | | fiber laser |
| | nonlinear amplifying | figure-8 fiber laser |
| | loop mirror | |

Several embodiments of different pulse fiber lasers are provided as follows. FIG. 11 is a schematic view of an all-fiber laser system according to an embodiment of the invention. With reference to FIG. 11, in this embodiment, an all-fiber laser system 200 includes a fiber 202. The fiber 202 further includes a gain fiber 204. After the fiber 202 receives a pump light from a pump light source 206, the pump light is circulated on the fiber and generates gain in the gain fiber 204. A light isolator 208, a power synthesizer 210, two polarization controllers 212 and 214, and a fiber-optical polarization beam splitter lens 216 are further provided on the fiber 202. The fiber-optical polarization beam splitter lens 216 provides a laser output as well. The two polarization controllers 212 and 214 are controlled by the control apparatus 30 of FIG. 1 to adjust the polarization state.

FIG. 12 is a schematic view of an all-normal-dispersion fiber laser system according to an embodiment of the invention. With reference to FIG. 12, in this embodiment, an all-normal-dispersion fiber laser system 300 includes a fiber 302. After the fiber 302 receives a pump light from a pump light source 308, the pump light is circulated on the fiber and generates gain in a gain fiber 304. A power synthesizer 306, two fiber collimators 310a and 310b, a quarter-wave plate 312, a quarter-wave plate 316, a half-wave plate 314, a beam splitter lens 320, and a light isolator 318 are further provided on the fiber 302. The power synthesizer 306 provides a laser output as well. The quarter-wave plate 312, the quarter-wave plate 316, and the half-wave plate 314 are controlled by the control apparatus 30 of FIG. 1 to adjust the polarization state.

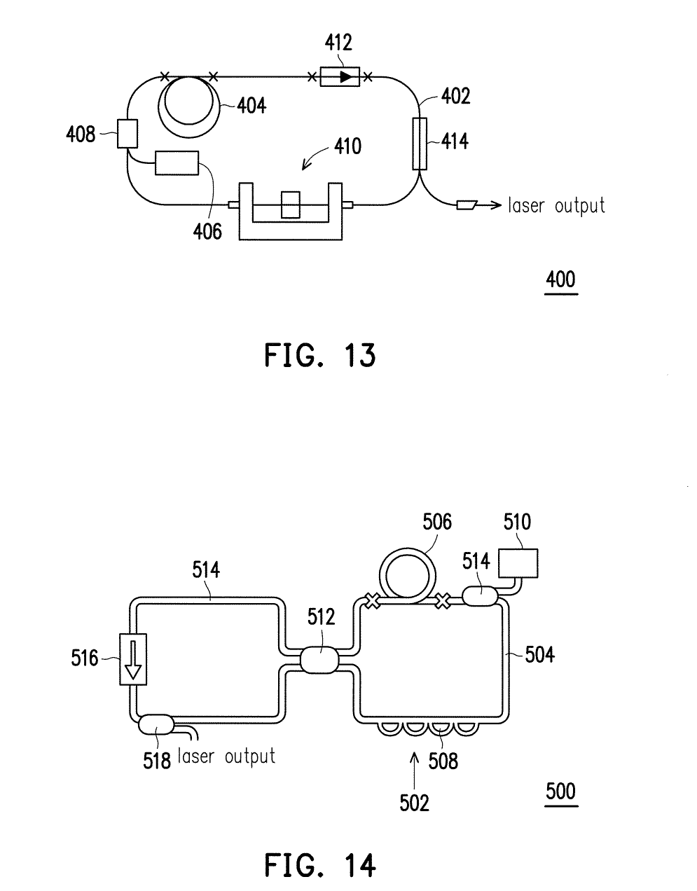

FIG. 13 is a schematic view of a non-all-fiber laser system that uses a liquid crystal as a polarization control component according to an embodiment of the invention. With reference to FIG. 13, in this embodiment, a non-all-fiber laser system 400 includes a fiber 402. After the fiber 402 receives a pump light from a pump light source 406 by a power synthesizer 408, the pump light is circulated on the fiber and generates gain in a gain fiber 404. A liquid crystal polarization control component 410 and a light isolator 412 are further provided on the fiber 402. The fiber-optical polarization beam splitter lens 414 provides a laser output as well. The liquid crystal polarization control component 410 is controlled by the control apparatus 30 of FIG. 1 to adjust the polarization state.

FIG. 14 is a schematic view of a figure-8 fiber laser system according to an embodiment of the invention. With reference to FIG. 14, in this embodiment, a figure-8 fiber laser system 500 includes two fibers 504 and 514, which are connected together to form a shape of FIG. 8 by a fiber coupler 512. The fiber coupler 512 is, for example, with a coupling relation of 50/50. After a nonlinear amplifying loop mirror 502 constituted by the fiber 504 receives a pump light from a pump light source 510 by a power synthesizer 514, the pump light is circulated on the fiber and generates gain in a gain fiber 506. A single set of a polarization control device 508 is further provided on the fiber 504. The polarization control device 508 is controlled by the control apparatus 30 of FIG. 1 to adjust the polarization state. In addition, a light isolator 516 and a fiber coupler 518 are also provided on the fiber 514. The fiber coupler 518 provides a laser output as well.

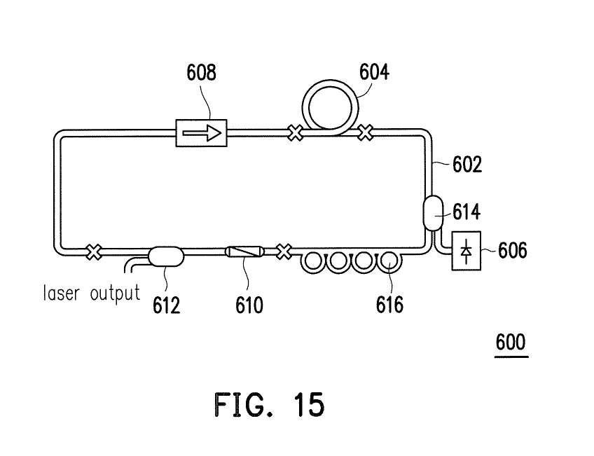

FIG. 15 is a schematic view of an all-normal-dispersion fiber laser system that uses a single polarization controller according to an embodiment of the invention. With reference to FIG. 15, in this embodiment, an all-normal-dispersion fiber laser system 600 includes a fiber 602. After the fiber 602 receives a pump light from a pump light source 606 by a power synthesizer 614, the pump light is circulated on the fiber and generates gain in a gain fiber 604. A single set of a polarization control device 616, an inline polarizer 610, a fiber coupler 612 and a light isolator 608 is further provided on the fiber 602. The polarization control device 616 is controlled by the control apparatus 30 of FIG. 1 to adjust the polarization state. Serving as a replacement for a fiber-optical polarization beam splitter lens, the inline polarizer 610 and the fiber coupler 612 provide a laser output as well.

It should be noted that the fiber laser systems to which the invention is suitable for use are not limited to the listed embodiments. Generally speaking, the invention is at least suitable for use to laser system designs that generate a pulse output using nonlinear polarization rotation (NPR) or a nonlinear amplifying loop mirror (NALM). Thus, an intelligent mode-locked fiber laser system is built by following the method and mechanism provided in the invention. The polarization control component used therein is not limited to a waveplate, a liquid crystal or a polarization controller. As long as the component is electrically adjustable, it may be utilized in the invention.

In summary, in the invention, the intensity of the TPA signal of the photodiode is used to quickly determine whether the pulse signal outputted by the fiber laser system is a noise-like pulse or a mode-locked pulse. At the same time, the TPA signal of the photodiode is used as the feedback signal for the fiber laser system to quickly lock the noise-like pulse or the mode-locked pulse. This system is characterized by simple hardware installation, low cost, and easy applicability.

Although the embodiments are already disclosed as above, these embodiments should not be construed as limitations on the scope of the invention. It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. A fiber laser system, comprising:
a fiber laser outputting a pulse laser light, the pulse laser light comprising a noise-like pulse light laser or a mode-locked pulse laser light;
a laser light detecting apparatus comprising a photodiode that absorbs the pulse laser light outputted from the fiber laser, wherein the photodiode generates a two-photon absorption signal that has two stable voltage states, which are distinguishable, in terms of the noise-like pulse laser light and the mode-locked pulse laser light respectively; and
a control apparatus reading an output signal of the photodiode and automatically adjusting the fiber laser, according to a selection between the two stable voltage states, to obtain the noise-like pulse laser light or the mode-locked pulse laser light.

2. The fiber laser system as recited in claim 1, wherein the two stable voltage states are two stable absorption states of the photodiode.

3. The fiber laser system as recited in claim 1, wherein one of the two stable voltage states is selected using a threshold value.

4. The fiber laser system as recited in claim 1, wherein the control apparatus, by a computer system, adjusts an optical component configured to change a polarization state in the fiber laser, thereby obtaining the pulse laser light as outputted.

5. The fiber laser system as recited in claim 1, wherein the fiber laser is a dispersion-mapped fiber laser, an all-normal-dispersion fiber laser, or a figure-8 fiber laser.

6. The fiber laser system as recited in claim 1, wherein the fiber laser is a nonlinear polarization rotation fiber laser and comprises:
a polarization beam splitter adjusting a polarization state inside a laser cavity using the control apparatus, thereby forming an output of the pulse laser light.

7. The fiber laser system as recited in claim 6, wherein the polarization beam splitter comprises:
a first quarter-wave plate that is rotatable;
a second quarter-wave plate that is rotatable;
a half-wave plate that is rotatable; and
a polarization beam splitter lens directing the pulse laser light out to enter the control apparatus,
wherein the control apparatus automatically controls respective rotating angles of the first quarter-wave plate, the second quarter-wave plate and the half-wave plate.

8. The fiber laser system as recited in claim 7, wherein the first quarter-wave plate and the half-wave plate are disposed adjacent to each other and have opposite rotating directions.

9. The fiber laser system as recited in claim 7, wherein the fiber laser forms a ring-shaped cavity path and comprises:
a pump light source emitting a laser pump light, and
a Yb-doped fiber receiving the laser pump light to perform amplification.

10. The fiber laser system as recited in claim 1, wherein the fiber laser is a nonlinear amplifying loop mirror fiber laser and comprises a polarization control device, the polarization control device comprising:
a polarization controller provided on a ring-shaped fiber cavity path,
wherein the polarization controller is adjusted by the control apparatus to obtain the pulse laser light as outputted.

11. The fiber laser system as recited in claim 1, wherein the fiber laser comprises a liquid crystal phase retarder, which is adjusted by the control apparatus to obtain the pulse laser light as outputted.

12. The fiber laser system as recited in claim 1, wherein the photodiode is a GaAsP photodiode.

13. The fiber laser system as recited in claim 1, wherein the laser light detecting apparatus further comprises a focus lens that focuses the pulse laser light outputted from the fiber laser to be inputted to the photodiode.

14. A method for generating a pulse laser light, comprising:
outputting a pulse laser light using a fiber laser, wherein the pulse laser light comprises a noise-like pulse light laser or a mode-locked pulse laser light;
absorbing the pulse laser light using a photodiode, wherein a two-photon absorption signal of the photodiode has two stable voltage states, which are distinguishable, in terms of the noise-like pulse light laser and the mode-locked pulse laser light; and
by a control apparatus, reading an output signal of the photodiode and automatically adjusting the fiber laser, according to a selection between the two stable absorption states, to obtain the noise-like pulse laser light or the mode-locked pulse laser light.

15. The method for generating a pulse laser light as recited in claim 14, wherein the two stable absorption states are two stable voltage states in terms of an output signal of the photodiode.

16. The method for generating a pulse laser light as recited in claim 14, wherein one of the two stable absorption states is selected using a threshold value.

17. The method for generating a pulse laser light as recited in claim 14, wherein the control apparatus, by a computer system, adjusts an optical component configured to change a polarization state in the fiber laser, thereby obtaining the pulse laser light as outputted.

18. The method for generating a pulse laser light as recited in claim 14, wherein the fiber laser is an all-normal-dispersion fiber laser and comprises:
a polarization beam splitter adjusting nonlinear polarization rotation using the control apparatus, thereby changing a polarization state of the pulse laser light.

19. The method for generating a pulse laser light as recited in claim 18, wherein the polarization beam splitter comprises:
a first quarter-wave plate that is rotatable;
a second quarter-wave plate that is rotatable;
a half-wave plate that is rotatable; and
a polarization beam splitter lens directing the pulse laser light out to enter the control apparatus,
wherein the control apparatus automatically controls respective rotating angles of the first quarter-wave plate, the second quarter-wave plate, and the half-wave plate.

20. The method for generating a pulse laser light as recited in claim 18, wherein the fiber laser comprises a polarization control device or a liquid crystal phase retarder that is controlled by the control apparatus to obtain the pulse laser light as outputted.
